(19) United States
(12) Patent Application Publication
(10) Pub. No.: US 2026/0066819 A1
(43) Pub. Date: Mar. 5, 2026

(54) DIFFERENTIAL H-BRIDGE DRIVER

(71) Applicant: Texas Instruments Incorporated, Dallas, TX (US)

(72) Inventors: Krishnamurthy Ganapathi Shankar, Dallas, TX (US); Apoorva Awasthy, Bangalore (IN); Richeek Maitra, Bangalore (IN)

(21) Appl. No.: 18/821,578

(22) Filed: Aug. 30, 2024

(51) Int. Cl. H02P 7/03; H02P 7/29

(52) U.S. Cl. CPC H02P 7/04; H02P 7/29

(57) ABSTRACT

Motor driver circuitry including an H-bridge circuit having first and second outputs. The circuitry further includes a first transistor, having a first terminal, a second terminal coupled to the first output, and a control terminal, and a second transistor, having a first terminal coupled to the first terminal of the first transistor, a second terminal coupled to the second output, and a control terminal. A common mode circuit has an enable input and an output coupled to the H-bridge circuit. Transistor driver circuitry has an enable input and an output coupled to the control terminals of the first and second transistors. A comparator has an input coupled to the first output, and an output coupled to the enable input of the common mode circuit and the enable input of the transistor driver circuitry.

### BACKGROUND

This relates to circuitry and methods for driving electronic motors.

Direct current (DC) motors are commonly used in a wide range of applications requiring the conversion of electrical energy into mechanical torque. DC motors generate mechanical torque from the rotation of an electromagnetic rotor in a magnetic field in response to current applied to the rotor coil. Common types of DC motors include brushed DC motors, brushless DC motors, and stepper motors.

In brushed DC motors, coupling of the DC current to the rotor is made by brushes that contact a commutator at the rotor shaft; gaps in the commutator prevent short circuiting as coil current is reversed. Brushless DC motors (BDCs) are electronically commutated by controller and driver circuitry. An electronic sensor detects the angle and velocity of the rotor, and controls driver transistors to switch current through the windings to reverse or turn off the current so the electromagnets create torque in one direction. BDC motors may be unipolar (a single pair of poles) or multipolar (two or more pairs of poles). BDC motors have a long history and continue to have widespread use in many modern implementations due to their simplicity, ease of adjustable control, and utility in both low power and high power applications.

Stepper motors are a type of BDC motor in which one or more coils are driven by motor driver circuitry to control the rotational position and velocity of the rotor, for example to rotate the rotor to a particular rotational position by driving coil current with a variable amplitude, and to hold the rotor at that position by driving the coil current at a constant amplitude.

Modern automobiles commonly use BDC motors for such functions as power windows, HVAC control, seat positioning, mirror adjustment, windshield wipers, electronic shifters, and the like. BDC motors are also widely used in industrial applications.

In many applications, the poles of modern BDC motors are driven from metal-oxide-semiconductor (MOS) field-effect transistors (MOSFETs) with gates driven by pulse-width modulation (PWM) signals from a driver circuit to provide the appropriate current waveform to the coils. The driver transistors may be arranged as an “H-bridge,” with pull-up and pull-down MOSFET transistors coupled to each side of the motor coil.

FIG. 1A illustrates a prior art example of H-bridge 100 as used in driving a motor coil. H-bridge 100 includes n-channel metal-oxide-semiconductor (NMOS) transistors 102, 104, 160, 108. H-bridge 100 is coupled to cable network 110, which includes wires C1, C2. Cable network 110 is coupled to opposing sides of coil 130 of motor M.

Within H-bridge 100, NMOS transistor 102 has a terminal coupled to a power supply terminal receiving voltage VM, and a terminal coupled to output OUT1 of H-bridge 100. NMOS transistor 104 has a terminal coupled to output OUT1 and a terminal coupled to a common terminal that receives a common potential (e.g., ground). Similarly, NMOS transistor 104 has a terminal coupled to the power supply terminal receiving voltage VM, and a terminal coupled to output OUT2 of H-bridge 100. NMOS transistor 106 has a terminal coupled to output OUT2 and a terminal coupled to ground. As such, NMOS transistors 102, 106 are “pull-up” transistors of H-bridge 100, and NMOS transistors 104, 108 are “pull-down” transistors of H-bridge 100. Gate terminals of NMOS transistors 102, 104, 160, 108 receive gate drive signals HSGATE1, LSGATE1, HSGATE2, LSGATE2, respectively, from gate driver circuitry (not shown). In this prior art example, NMOS transistors 102, 106 can be referred to as the “high side” transistors of H-bridge 100, and NMOS transistors 104, 108 as the “low side” transistors of H-bridge 100.

### SUMMARY

According to an example, an apparatus includes an H-bridge circuit having first and second outputs; a first transistor, having a first terminal, a second terminal coupled to the first output, and a control terminal; a second transistor, having a first terminal coupled to the first current terminal of the first transistor, a second terminal coupled to the second output, and a control terminal; a common mode circuit having an enable input and having an output coupled to the H-bridge circuit; transistor driver circuitry having an enable input and an output coupled to the control terminals of the first and second transistors; and a comparator having an input coupled to the first output and an output coupled to the enable input of the common mode circuit and the enable input of the transistor driver circuitry.

According to another example, motor driver circuitry includes an H-bridge circuit including first and second transistors coupled to a first output and third and fourth transistors coupled to a second output, each of the first, second, third, and fourth transistors having a control terminal; a fifth transistor, having a first terminal, a second terminal coupled to the first output, and a control terminal; a sixth transistor, having a first terminal coupled to the first terminal of the first transistor, a second terminal coupled to the second output, and a control terminal; and controller circuitry coupled to the control terminals of the driver transistors and of the first and second transistors. The controller circuitry is configured to selectively turn on and turn off the first, second, third, and fourth transistors, and to turn on the fifth and sixth transistors during an interval in which the first, second, third, and fourth transistors are turned off.

According to another example, a method includes turning on a first pull-up transistor coupled to a first output of an H-bridge circuit; turning off the first pull-up transistor; turning on first and second transistors responsive to a voltage at the first output falling to a common mode voltage plus an offset, the first and second transistors having first terminals coupled together, the first transistor having a second terminal coupled to the first output, and the second transistor having a second current terminal coupled to a second output of the H-bridge circuit; and providing the common mode voltage to one of the first and second outputs of the H-bridge circuit.

Example technical advantages enabled by one or more of these examples include a significant reduction in the net transient switching current to ground due to significant parasitic capacitance of long wires between the H-bridge and the driven motor coil. According to these examples, electromagnetic interference (EMI) emitted from the cable network can be reduced without slowing the slew rate of the H-bridge, thereby avoiding increased power consumption and thermal energy, higher switching losses, and increased dead time. Reduced EMI can also be attained without additional active or passive filters.

Other example technical advantages enabled by this disclosure are apparent to those of ordinary skill in the art having reference to the following specification together with its drawings.

### BRIEF DESCRIPTION OF THE DRAWINGS

FIG. 1A is an electrical diagram, in block form, of a prior art H-bridge circuit coupled to a motor coil.

FIG. 1B is a timing diagram illustrating an example of transient current spikes occurring at switching at an output of the H-bridge of FIG. 1A.

FIG. 2 is an electrical diagram, in block form, of an example motor driver system.

FIG. 3 is an electrical diagram, in block and schematic form, of example recirculation circuitry in the system of FIG. 2.

FIG. 4A is an electrical diagram, in schematic form, of example common mode circuitry in the recirculation circuitry of FIG. 3.

FIG. 4B is a timing diagram illustrating an example operation of the recirculation circuitry of FIG. 3.

FIG. 4C is a timing diagram illustrating an example of differential operation in the system of FIG. 2.

FIG. 5 is a flow diagram illustrating an example method of driving a motor with the system of FIG. 2.

The same reference numbers or other reference designators are used in the drawings to illustrate the same or similar (in function and/or structure) features.

### DETAILED DESCRIPTION

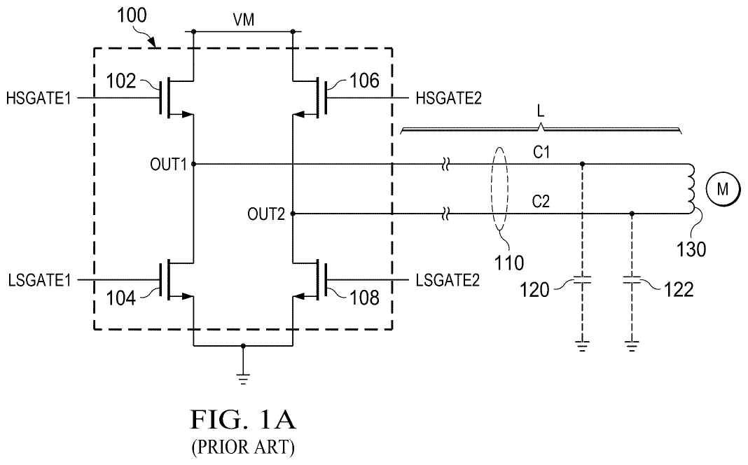

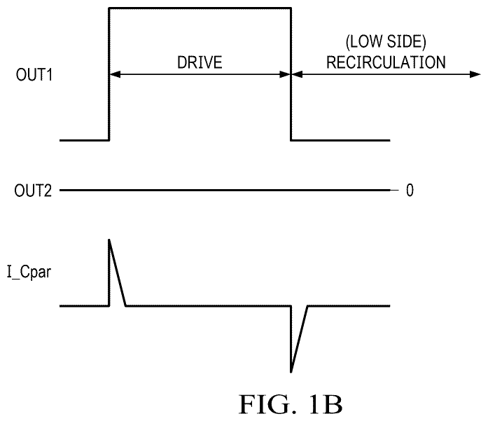

As noted above, FIG. 1A illustrates prior art H-bridge 100 as coupled by cable network 110 to motor coil 130 of a motor M. In operation, H-bridge 100 applies voltage and current at its outputs OUT1, OUT2, for example in a pulse-width-modulated (PWM) fashion, to drive current through motor coil 130 via wires C1, C2 of cable network 110. For example, a positive voltage pulse at output OUT1 relative to output OUT2 is driven by gate drivers (not shown) applying voltages on lines HSGATE1 and LSGATE2 to turn on NMOS transistors 102 and 108, respectively, and applying voltages on lines LSGATE1 and HSGATE2 to turn off NMOS transistors 104 and 106, respectively. The resulting voltage differential sources current through motor coil 130 and cable network 110, in a direction from output OUT1 to output OUT2. In a recirculation or decay interval following the PWM drive pulse, voltages are applied on lines HSGATE1 and LSGATE2 to turn off NMOS transistors 102 and 108, respectively. A short pulse at LSGATE1 or HSGATE2 may be applied at the beginning of the decay interval to more rapidly discharge outputs OUT1, OUT2 through transistors 104 and 106.

Conversely, current may be sourced through motor coil 130 in the opposite direction, from output OUT2 to output OUT1, by the gate drivers applying voltages on lines HSGATE2 and LSGATE1 to turn on NMOS transistors 106 and 104, respectively, and applying voltages on lines HSGATE1 and LSGATE2 to turn off NMOS transistors 102 and 108, respectively.

In some implementations, cable network 110 between H-bridge 100 and motor M can be quite long. For example, the length L of cable network 110 in automotive implementations can be as long as one meter. At such a length, wires C1, C2 exhibit significant parasitic capacitance to ground (e.g., chassis ground), as represented in FIG. 1A by capacitances 120, 122. These parasitic capacitances 120, 122 can cause significant transient current spikes during the PWM driving of motor M.

FIG. 1B illustrates an example of transient current spikes in drive and recirculation phases of a PWM cycle due to the parasitic capacitances 120, 122 of wires C1, C2. In this example, H-bridge 100 drives output OUT1 to a high voltage (e.g., at or near power supply voltage VM) during the drive phases of the PWM cycle, while holding output OUT2 at a lower voltage (e.g., at or near ground). In the recirculation phase of the PWM cycle, H-bridge 100 drives both outputs OUT1, OUT2 to ground, allowing the current through motor coil 130 to decay to zero. This operation is referred to as “low side recirculation.” Conversely, motor M may be driven in a “high side recirculation” mode by H-bridge 100 driving both of its outputs (e.g., output OUT1) to a high voltage (e.g., at or near power supply voltage VM). The example of FIG. 1B corresponds to the low side recirculation drive mode.

As shown in FIG. 1B, a positive spike of transient current I_Cpar results from the low-to-high voltage transition at output OUT1 at the beginning of a drive phase. At the end of the drive phase and beginning of the low side recirculation phase, a negative spike of transient current I_Cpar results from the high-to-low voltage transition of output OUT1. These spikes of transient current I_Cpar conduct in a parasitic ground loop through parasitic capacitances 120, 122 of wires C1, C2. The amplitude of these ground current spikes depends on the rise and fall times of the voltage at output OUT1 as driven by H-bridge 100, the size of parasitic capacitances 120, 122, and the power supply voltage VM.

In the automotive context, these transient current spikes may be quite large, due to the large parasitic capacitance from the lengths of wires C1, C2 (e.g., up to one meter) and the relatively high power supply voltage VM (e.g., on the order of tens of volts). The long wires C1, C2 behave as antennae for these large transient current spikes, emitting significant electromagnetic interference (EMI) that adversely affects other electronic functionality in the system. This EMI can be reduced by slowing the slew rate at the H-bridge outputs, but this can cause higher power dissipation in the motor drive circuitry and degraded performance in the form of longer dead times and higher reverse recovery times. Additional active filtering at the power supply and ground terminals may also control the transient current spikes, but adds substantial cost to the overall system.

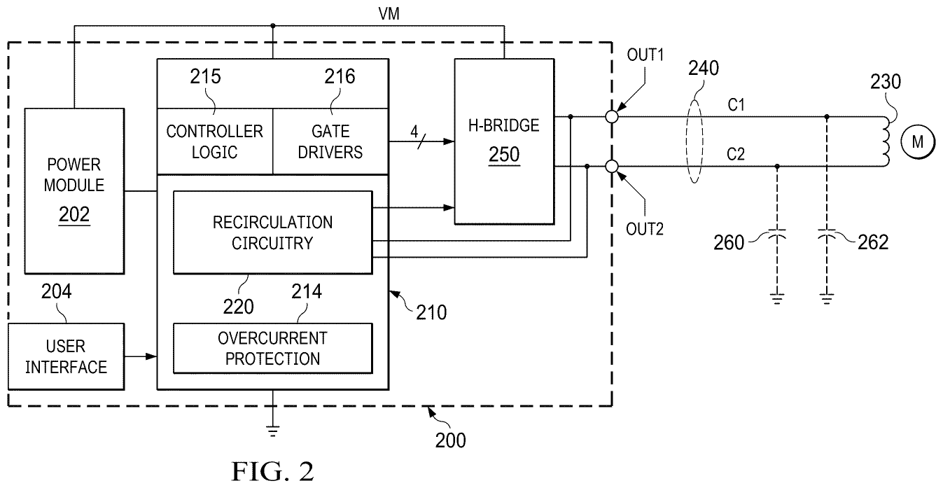

FIG. 2 illustrates example motor driver system 200, as implemented with cable network 240 and motor coil 230 of motor M. Cable network 240 includes wires C1, C2, which exhibit parasitic capacitances 260, 262, respectively. System 200 includes power module 202, user interface 204, controller circuitry 210, and H-bridge 250. Controller circuitry 210 includes overcurrent protection circuitry 214, controller logic 215, gate drivers 216, and recirculation circuitry 220.

H-bridge 250 of motor driver system 200 may be constructed as two pairs of push-pull driver transistors as described above in connection with FIG. 1A and as further described below. In the example of FIG. 2, H-bridge 250 has outputs OUT1, OUT2 coupled to terminals of motor coil 230 of motor M by respective wires C1, C2 of cable network 240. H-bridge 250 has a power supply terminal receiving power supply voltage VM, and has inputs coupled to outputs of gate drivers 216 of controller circuitry 210. Gate drivers 216 generate the appropriate gate drive signals to turn on and off the driver transistors in H-bridge 250 to drive motor coil 230.

Motor driver system 200 may be implemented as a single integrated circuit. In that case, motor driver system 200 can be referred as an integrated motor driver system, in that H-bridge 250 is implemented into the same integrated circuit with controller circuitry 210. Alternatively, motor driver system 200 may be implemented as multiple integrated circuits and electronic devices, including for example with controller circuitry 210 in a separate integrated circuit from H-bridge 250.

Controller circuitry 210 of motor driver system 200 in this example includes controller logic 215, in the form of digital logic, and appropriate analog circuitry (if any), arranged to generate the appropriate drive signals from its gate drivers 216 to H-bridge 250. Controller logic 215 in this example may be realized by fixed function digital logic circuitry, field programmable logic arrays (FPLAs), an application specific integrated circuit, programmable logic circuitry (such as in the form of a microprocessor or microcomputer), or as some combination of these implementation types. Gate drivers 216 may be constructed of push-pull drivers or other transistor arrangements for applying the appropriate gate drive to power transistors in H-bridge 250.

Controller circuitry 210 is coupled to user interface 204 in motor driver system 200. User interface 204 may receive external user inputs, and communicate signals corresponding to those inputs to controller circuitry 210. For example, a user input received at user interface 204 may indicate a desired speed or position, in response to which controller circuitry 210 generates the appropriate drive signals to H-bridge 250 to attain that speed or position (e.g., a specific angular position or velocity, or a profile of position or velocity over a time interval, etc.). In another example, controller circuitry 210 may itself be programmed with the desired motor speed or position, such that an actuation signal from a user, received via interface 204, initiates execution of an algorithm that outputs control signals corresponding to the desired position, speed, and/or speed or position profile. In other examples, controller circuitry 210 may operate to autonomously control the position and speed of motor M, without requiring user input as an initiating or control signal. In any case, controller circuitry 210 controls the position and speed of motor M through the drive signals applied by gate drivers 216 to H-bridge 250.

Controller circuitry 210 may further include other functionality, such as overcurrent protection circuitry 214 shown in FIG. 2. Overcurrent protection circuitry 214 may receive sensed coil current signals, and cause controller circuitry 210 to remove gate drive from H-bridge 250 in the event of an overcurrent condition. Other ancillary circuits (e.g., thermal shutdown protection, position feedback, undervoltage lockout, etc.) may additionally be included in controller circuitry 210.

Motor driver system 200 in this example also includes power module 202, which receives one or more external power supply voltages (e.g., power supply voltage VM). Power module 202 may include voltage regulators and other power management circuits for generating or communicating power supply and reference voltages to controller circuitry 210, H-bridge 250, and other circuitry of motor driver system 200.

Motor driver system 200 in this example also includes recirculation circuitry 220 as part of controller circuitry 210. Recirculation circuitry 220 is coupled to outputs OUT1, OUT2 of H-bridge 250, and also has an output coupled to H-bridge 250, for example to one or more of its driver transistors, or indirectly to H-bridge 250 via one or more of gate drivers 216. Recirculation circuitry 220 in this example operates to reduce EMI caused by unbalanced ground loop current that may be conducted through the parasitic capacitance of cable network 240.

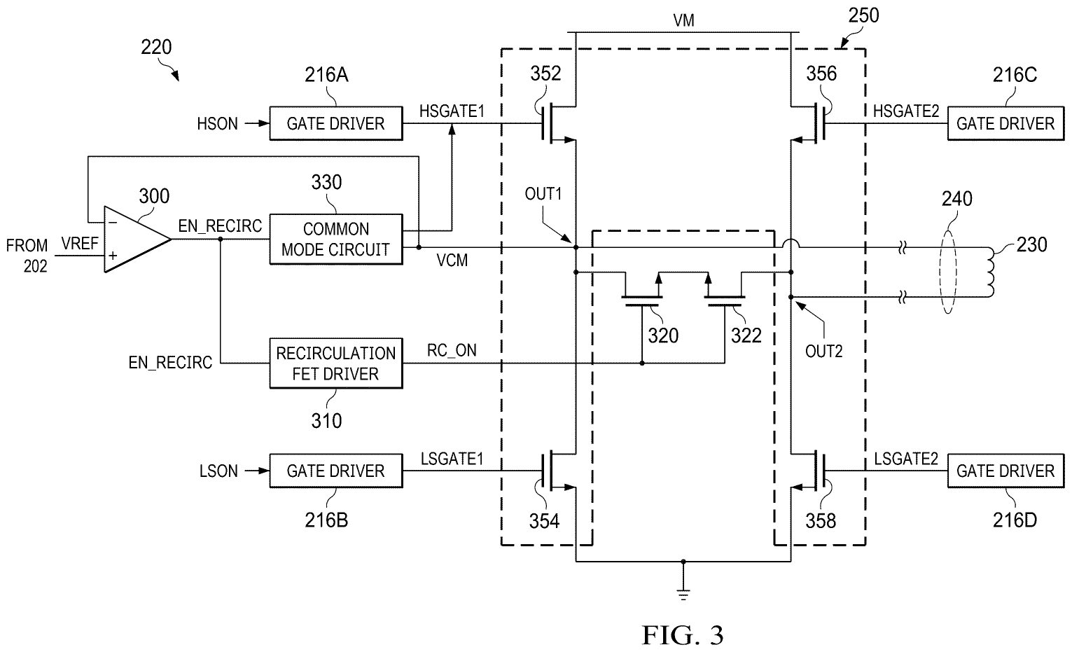

FIG. 3 illustrates an example of recirculation circuitry 220 in combination with gate drivers 216 and H-bridge 250, driving motor coil 230 via cable network 240. H-bridge 250 as shown in FIG. 3 includes power transistors 352, 354, 356, 358. Gate drivers 216 include gate drivers 216A, 216B, 216C, 216D associated with (e.g., that drive the control terminals of) power transistors 352, 354, 356, 358, respectively. Recirculation circuitry 220 includes comparator 300, recirculation FET driver 310, transistors 320, 322, and common mode circuit 330.

H-bridge 250 in this example is arranged to drive motor coil 230 with relatively high current (e.g., on the order of one ampere), from a relatively high voltage (e.g., on the order of tens of volts) sourced from power supply voltage VM. In such high-voltage and high-current implementations, transistors 352, 354, 356, 358 in H-bridge 250 may be constructed as power field-effect transistors (FETs), including metal-oxide-semiconductor FETs (MOSFETs), in technologies suitable for the expected voltages and currents. Examples of suitable power FET technologies include laterally-diffused MOSFETs (LDMOS), drain-extended MOSFETs (DEMOS), vertically-diffused MOSFETs (VMOS), and the like. Alternatively, transistors 352, 354, 356, 358 may be bipolar junction transistors (BJTs) constructed in a manner appropriate for the expected voltages and currents.

In the example of FIG. 3, transistors 352, 354, 356, 358 are arranged as a pair of push-pull drivers coupled to opposing terminals of motor coil 230. Transistors 352 and 354 form a push-pull driver coupled to output OUT1, and transistors 356 and 358 form a push-pull driver coupled to output OUT2. Transistor 352 has a first current terminal coupled to output OUT1 of H-bridge 250, and a second current terminal coupled to a power supply terminal receiving voltage VM. Transistor 354 has a first current terminal coupled to a common terminal that receives a common potential (e.g., ground), and a second current terminal coupled to output OUT1. Similarly, transistor 356 has a first current terminal coupled to output OUT2 of H-bridge 250 and a second current terminal coupled to the power supply terminal receiving voltage VM. Transistor 358 has a first current terminal coupled to ground and a second current terminal coupled to output OUT2. As such, transistors 352, 356 are “pull-up” transistors at outputs OUT1 and OUT2, respectively. Transistors 354, 358 are “pull-down” transistors at outputs OUT1 and OUT2, respectively. Current terminals are also referred to herein simply as terminals.

Control terminals of transistors 352, 354, 356, 358 receive gate drive signals HSGATE1, LSGATE1, HSGATE2, LSGATE2, respectively, from gate drivers 216A, 216B, 216C, 216D, respectively. As described above, gate drivers 216A, 216B, 216C, 216D are controlled by controller logic 215 to apply the appropriate gate drive signals HSGATE1, LSGATE1, HSGATE2, LSGATE2, for example in a pulse-width-modulated (PWM) manner to drive motor coil 230 in motor M at a selected torque.

In example H-bridge 250 of FIG. 3, transistors 352, 354, 356, 358 are implemented as n-channel MOS (NMOS) transistors. Alternatively, these devices may be implemented as p-channel MOS (PMOS) transistors, as a combination of PMOS and NMOS transistors, or as n-p-n or p-n-p type bipolar junction transistors (BJTs). In this description for the case of transistors 352, 354, 356, 358 implemented as NMOS transistors, the first current terminal corresponds to the source terminal (also referred to herein as the source), the second current terminal corresponds to the drain terminal (also referred to herein as the drain), and the control terminal corresponds to the gate terminal (also referred to herein as the gate). Similar nomenclature would apply to transistors 352, 354, 356, 358 implemented as PMOS devices. For the case of bipolar transistors, the first current terminal corresponds to the emitter terminal (also referred to herein as the emitter), the second current terminal corresponds to the collector terminal (also referred to herein as the collector), and the control terminal corresponds to the base terminal (also referred to herein as the base).

Comparator 300 of recirculation circuitry 220 has one input (e.g., a positive input) receiving a reference voltage VREF, for example from a voltage regulator or other circuitry in power module 202. Comparator 300 has another input (e.g., a negative input) coupled to output OUT1 of H-bridge 250, at the source terminal of pull-up transistor 352 and the drain terminal of pull-down transistor 354. Comparator 300 has an output coupled to an enable input of recirculation FET driver 310 and an enable input of common mode circuit 330. At its output, comparator 300 communicates a signal EN_RECIRC in response to a comparison of the voltages at its inputs.

Transistors 320 and 322 in this example are implemented as NMOS transistors having first current terminals (e.g., source terminals) coupled to one another. Transistor 320 has a second current terminal (e.g., drain terminal) coupled to output OUT1 of H-bridge 250. Transistor 322 has a second current terminal (e.g., drain terminal) coupled to output OUT2 of H-bridge 250. Transistors 320 and 322 of recirculation circuitry 220 in this example may be constructed as power transistors (e.g., LDMOS, DEMOS, VMOS, etc.), but of a smaller size than power transistors 352, 354, 356, 358.

Recirculation FET driver 310 has an enable input coupled to the output of comparator 300 to receive signal EN_RECIRC, and an output or outputs coupled to the control terminals (e.g., gate terminals) of transistors 320 and 322. Recirculation FET driver 310 includes one or more gate driver circuits arranged to turn on transistors 320, 322 (e.g., with a high logic level of signal RC_ON) when enabled by an active level (e.g., high logic level) of signal EN_RECIRC from comparator 300. For example, recirculation FET driver 310 may be constructed as one or more single-ended or push-pull drivers, in which signal EN_RECIRC provides the gate drive (in a MOS implementation) for the driver transistors. As described below, recirculation FET driver 310 turns on transistors 320, 322 in the recirculation (or decay) phase of the PWM cycle so that the inductor current conducted by motor coil 230 may recirculate through transistors 320, 322. For purposes of this description, transistors 320, 322 may thus be referred to as recirculation transistors 320, 322. In response to an inactive level (e.g., low logic level) of signal EN_RECIRC, recirculation FET driver 310 operates to communicate signal RC_ON at a low logic level to turn off transistors 320, 322.

Common mode circuit 330 has an input coupled to output OUT1 of H-bridge 250, and an output coupled to the gate terminal of one of driver transistors 352, 354, 356, 358. In this example, common mode circuit 330 has an output coupled to the gate terminal of driver transistor 352, and when enabled by an active level of signal EN_RECIRC from comparator 300, controls driver transistor 352 to provide a common mode voltage VCM at output OUT1.

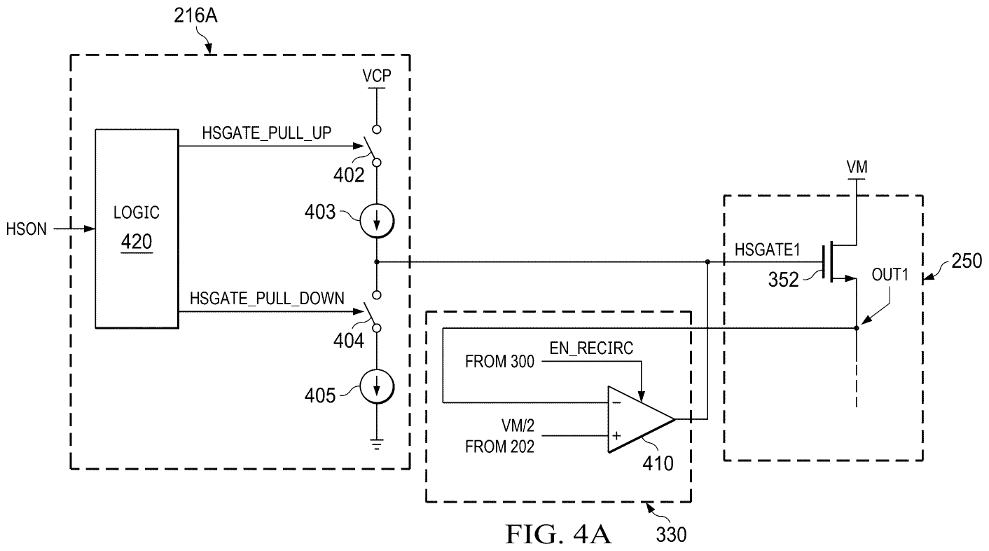

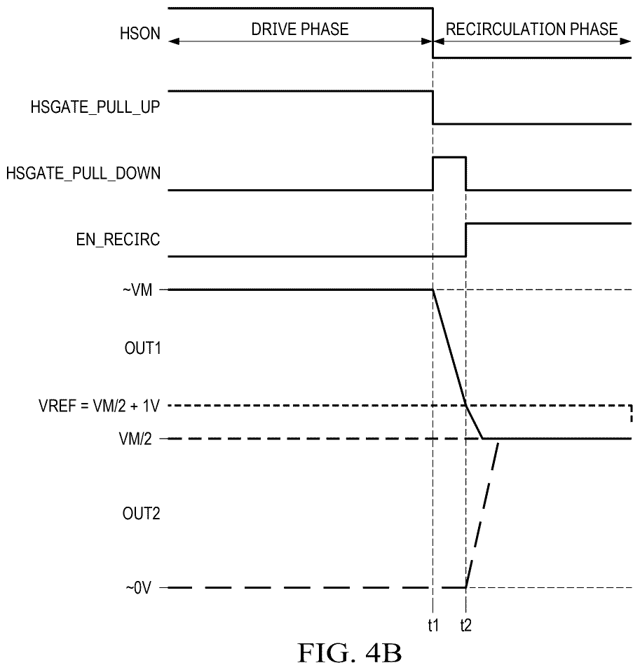

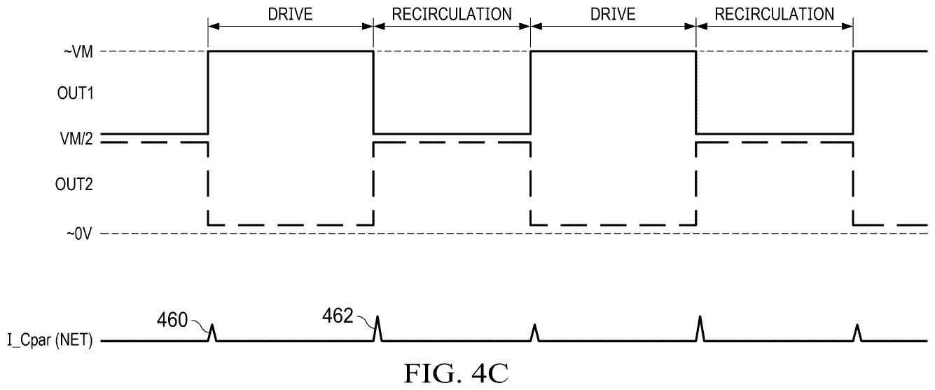

FIG. 4A illustrates an example of common mode circuit 330 as coupled to H-bridge 250 and gate driver 216A. In this example, common mode circuit 330 includes operational amplifier (op amp) 410, and gate driver 216A includes switches 402 and 404, current sources 403 and 405, and logic circuit 420.

Switch 402 of gate driver 216A has a first terminal coupled to a power supply terminal (e.g., receiving a voltage VCP), a second terminal coupled to first terminal of current source 403, and a control terminal receiving signal HSGATE_PULL_UP, for example from logic circuit 420 in response to signal HSON from controller logic 215. Current source 403 has a second terminal coupled to the gate terminal of pull-up transistor 352. Switch 404 has a first terminal coupled to the gate terminal of pull-up transistor 352 and the second terminal of current source 403, a second terminal coupled to a first terminal of current source 405, and a control terminal receiving signal HSGATE_PULL_DOWN, for example from logic circuit 420 in response to signal HSON from controller logic 215. Current source 405 has a second terminal coupled to circuit ground in this example. Switches 402 and 404 may be constructed as single transistors, as pass gates (e.g., NMOS and PMOS transistors connected in parallel and receiving complementary gate signals), or as other forms of semiconductor switches. Current sources 403 and 405 may each be constructed as a transistor, such as a MOS transistor receiving a regulated gate voltage to conduct a controlled current in the on-state.

Op amp 410 in common mode circuit 330 has a positive, or non-inverting, input coupled to, for example, a voltage regulator or other circuit in power module 202 that provides a common mode voltage. The positive input of op amp 410 is also referred to herein as a common mode voltage input. In this example, the common mode voltage received at the common mode voltage input of op amp 410 is one-half the power supply voltage VM (e.g., VM/2), which is at about the midpoint of the potentials to which outputs OUT1, OUT2 are driven in drive phases of the PWM cycle. Other voltage levels may alternatively be applied at this input of op amp 410, depending on the application and on the signal levels driven at outputs OUT1, OUT2 during drive phases. Op amp 410 has a negative, or inverting, input coupled to output OUT1, and an output coupled to the gate terminal of pull-up transistor 352. Op amp 410 has an enable input receiving signal EN_RECIRC. For example, signal EN_RECIRC may enable and disable an output stage of op amp 410.

FIG. 4B illustrates an example of the operation of common mode circuit 330 and recirculation circuitry 220 during a transition from a drive phase of a PWM cycle to the recirculation phase. Control signal HSON shown in FIG. 4B represents a signal generated by controller circuitry 210 (e.g., generated by controller logic 215 and forwarded to logic circuit 420 of gate driver 216A), and in response to which gate driver 216A turns on and turns off pull-up transistor 352 of H-bridge 250 in drive and recirculation phases, respectively, of the PWM cycle. Gate driver 216B receives a similar control signal LSON. e.g., from controller logic 215. In this example of FIG. 4B, control signal HSON is at a high logic level prior to time t1, enabling a drive phase of the PWM cycle. In response to the high logic level of signal HSON, signal HSGATE_PULL_UP is at a high logic level, closing switch 402 and causing current source 403 to source current into the gate of pull-up transistor 352 to turn it on. Pull-up transistor 352 in its on state pulls output OUT1 of H-bridge 250 to a high voltage, for example near power supply voltage VM. During this time, gate driver 216D has turned on pull-down transistor 358 in H-bridge 250, pulling output OUT2 of H-bridge 250 to a low voltage, for example near ground (e.g., 0V).

Referring to FIG. 3, comparator 300 compares the high voltage at output OUT1 to reference voltage VREF, which in this example is at the common mode voltage VM/2 plus a selected offset. This offset voltage is selected according to the particular implementation. In this example, reference voltage VREF is about 1V above common mode voltage VM/2 (e.g., the selected offset voltage is about 1V). In response to the voltage at output OUT1 being above the reference voltage VREF, comparator 300 outputs a low logic level at its output as enable signal EN_RECIRC, disabling common mode circuit 330 (e.g., op amp 410) and recirculation FET driver 310. In response, recirculation transistors 320, 322 are held off by recirculation FET driver 310. Op amp 410 in common mode circuit 330 is also disabled (e.g., its output stage is disabled) by the low logic level of enable signal EN_RECIRC, causing its output to float.

At time t1, control signal HSON makes a high-to-low transition, ending the drive phase and initiating the recirculation or delay phase of the PWM cycle. In response to the transition of control signal HSON, signal HSGATE_PULL_UP is driven to a low logic level to open switch 402, and signal HSGATE_PULL_DOWN is driven to a high logic level, closing switch 404. With switch 404 closed, current source 405 discharges the gate of pull-up transistor 352, turning it off. In the recirculation phase following time t1, H-bridge 250 may be controlled by gate drivers 216 according to the “slow decay” mode.

In response to output OUT1 falling to a voltage below reference voltage VREF=VM/2+1V, which occurs at time t2 in FIG. 4B, comparator 300 outputs a high logic level as enable signal EN_RECIRC. Signal HSGATE_PULL_DOWN is driven low at this time, opening switch 404. The high logic level of enable signal EN_RECIRC after time t2 enables recirculation FET driver 310, which in turn issues a high logic level at signal RC_ON to the gate terminals of recirculation transistors 320 and 322. Recirculation transistors 320, 322 turn on in response, coupling outputs OUT1 and OUT2 together.

Referring to FIG. 4A, the high logic level of enable signal EN_RECIRC also enables op amp 410 in common mode circuit 330. When op amp 410 is enabled (e.g., when its output stage is enabled), it drives the gate voltage HSGATE1 of pull-up transistor 352 to a level that causes the voltage at output OUT1 to match common mode voltage VM/2 at the positive input of op amp 410. Because recirculation transistors 320 and 322 are also on at this time, output OUT2 is also driven to common mode voltage VM/2 through recirculation transistors 320 and 322. As shown in FIG. 4B, outputs OUT1 and OUT2 reach common mode voltage VM/2 shortly after time t2 in the recirculation phase of the PWM cycle.

This operation of recirculation circuitry 220 and H-bridge 250 results in motor driver system 200 driving outputs OUT1, OUT2 of H-bridge 250 differentially, rather than in a “single-ended” fashion with high side or low side recirculation. This differential drive results from recirculation circuitry 220 applying common mode voltage VCM to outputs OUT1 and OUT2 during recirculation phases of the PWM cycles.

FIG. 4C illustrates an example of this differential operation of motor driver system 200. During drive phases of the PWM cycle, H-bridge 250 drives output OUT1, at one end of motor coil 230, to a voltage at or near power supply voltage VM, and drives output OUT2, at the other end of motor coil 230, to a voltage at or near ground (e.g., 0V) . During recirculation phases of the PWM cycle, as described above, common mode circuit 330 controls a transistor in H-bridge 250 so that it drives a common mode voltage (e.g., one-half of power supply voltage VM, or VM/2) at one of outputs OUT1, OUT2, while recirculation FET driver 310 turns on transistors 320 and 322 to couple outputs OUT1 and OUT2 together. As shown in FIG. 4C, outputs OUT1 and OUT2 are both at or near the common mode voltage VM/2 during recirculation phases of the PWM cycle.

This differential drive of motor coil 230 according to this example significantly reduces spikes in the net transient current I_Cpar due to the cancellation of transient current absorbed by parasitic capacitances 260 and 262 of wires C1 and C2 coupled to outputs OUT1 and OUT2, respectively. FIG. 4C illustrates an example of the net parasitic current I_Cpar over a few PWM cycles for example motor drive system 200 of FIG. 2.

In this example, the driving of output OUT1 from VM/2 to VM at the beginning of a drive PWM phase causes a positive transient current spike to ground via parasitic capacitance 260 of wire C1, while the driving of output OUT2 from VM/2 to 0V at this time causes a negative transient current spike from ground via parasitic capacitance 262 of wire C2. These opposite polarity spikes occurring at the same time tend to cancel out one another, resulting in a relatively small net transient current spike 460. Conversely, the driving of output OUT1 from VM to VM/2 at the end of the drive PWM phase causes a negative transient current spike from parasitic capacitance 260 of wire C1, while the driving of output OUT2 from 0V to VM/2 at this time causes a positive transient current spike from parasitic capacitance 260 of wire C2. These opposite polarity spikes also tend to cancel out one another, resulting in a relatively small net transient current spike 462 conducted in the ground loop through the system chassis.

In the simulated example shown in FIG. 4B, the net current spike 462 at the end of the drive phase has a slightly higher amplitude than current spike 460 at the beginning of the drive phase, perhaps due to the strong drive current provided by H-bridge 250. Even so, simulation indicates that the net amplitudes of transient current spikes 460 and 462 exhibit a 30 dB improvement in EMI in the 1 to 2 MHz frequency range, and improved performance over the full frequency range (e.g., 50 MHz and beyond), as compared with prior art high or low side recirculation motor drivers.

The operation of recirculation circuitry 220 is described above for the case in which one polarity of current is driven through motor coil 230 (e.g., output OUT1 is driven high and output OUT2 is driven low during drive phases). Recirculation circuitry 220 may also include similar functionality for the case in which motor coil 230 is driven with the opposite current polarity (e.g., output OUT2 is driven high and output OUT1 is driven low during drive phases). For this opposite polarity case, recirculation circuitry 220 may selectively (e.g., via a logic circuit) couple either of outputs OUT1 and OUT2 to comparator 300, op amp 404, and the source terminal of NMOS transistor 402, depending on the polarity of the driven motor coil current. Alternatively, an additional instance of comparator 300 and common mode circuit 330 may be provided.

The differential motor coil drive provided by a motor driver system according to this example enables a significant reduction in the net transient current to ground due to the parasitic capacitance of long wires between the H-bridge and the driven motor coil. EMI emitted from the cable network can thus be reduced without requiring slowing of the slew rate of the H-bridge. This avoids the increased power consumption and thermal energy that would result from the higher switching losses and increased dead time of slower slew rates. Additional active or passive filters are also not required to attain this reduction in EMI.

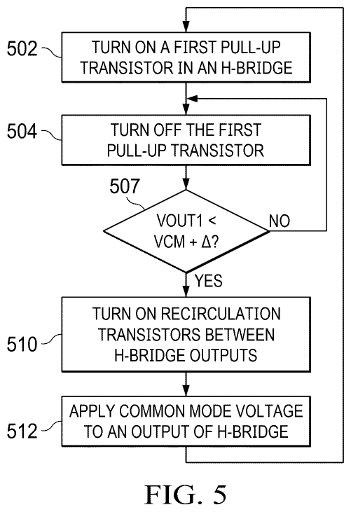

FIG. 5 illustrates an example method of operating a motor driver system such as system 200 described above relative to FIGS. 2 and 3. The example of FIG. 5 refers to the driving of a motor coil with current of one polarity (e.g., output OUT1 driven high and output OUT2 driven low during drive phases). Driving of the motor coil with current of the opposite polarity (e.g., output OUT2 driven high and output OUT1 driven low during drive phases), may be performed in the same manner.

Process block 502 is performed in a drive phase of the PWM cycle by gate driver 216A driving gate drive signals HSGATE1 to a high voltage to turn on pull-up transistor 352 of H-bridge 250. In the example of FIG. 4A, switch 402 is closed and switch 404 is open during this process block 502. Output OUT1 is thus pulled up toward power supply voltage VM. Similarly, output OUT2 is pulled down toward circuit ground by pull-down transistor 358 in its on state, sourcing current through motor coil 230 and generating torque at motor M.

Process block 504 is performed at the end of the drive PWM phase and at the beginning of the recirculation phase. In process block 504, switch 402 is open and switch 404 is closed in gate driver 216A to discharge the gate of pull-up transistor 352, turning it off. Slow decay mode recirculation may be enabled at H-bridge 250 during this time. With pull-up transistor 352 turned off, output OUT1 discharges toward circuit ground. In an example, the common mode voltage VCM corresponds to one-half the power supply voltage (e.g., VM/2), and the offset Δ is 1V. Decision 507 thus returns a “yes” result responsive to the voltage VOUT1 falling to a voltage of VM/2+1V.

In response to the voltage VOUT1 at output OUT1 falling to the voltage VCM+Δ (decision 507 returning a “yes”), recirculation FET driver 310 turns on transistors 320 and 322 in process block 510. Outputs OUT1 and OUT2 are coupled to one another as a result.

Also in response to the voltage VOUT1 at output OUT1 falling to the voltage VCM+Δ, common mode circuit 330 is enabled in process block 512 to control H-bridge 250 to drive a common mode voltage VCM at output OUT1. Common mode voltage VCM is also effectively applied to OUT2 due to recirculation transistors 320 and 322 being turned on in process block 510. The common mode voltage VCM is maintained at H-bridge outputs OUT1 and OUT2 for the remaining duration of the recirculation phase of the PWM, following which another drive phase begins with another instance of process block 502.

According to the example method of FIG. 5, therefore, the motor driver system differentially drives a motor coil, with one H-bridge terminal driven high (e.g., to power supply voltage VM) and its other terminal is pulled low (e.g., to circuit ground) during drive phases, and with both H-bridge terminals driven to a common mode voltage (e.g., VM/2) during recirculation phases. To the extent that transient current spikes are produced, due to parasitic capacitance of wires between the H-bridge outputs and the motor coil, those transient current spikes on the two wires are of opposite polarity and tend to cancel out. The net transient current conducted in the ground loop through the system chassis is thus much reduced from that of prior art motor driver systems, providing a significant reduction in EMI from the motor drive cable network.

Examples are described in this specification as implemented into a motor drive system in an automotive application, as such implementation can be advantageous in that context. However, aspects of these examples may be beneficially applied in alternative applications of motor drive systems beyond the automotive context. Accordingly, the above description is provided by way of example only, and is not intended to limit the true scope as claimed.

As used herein, the terms “terminal”, “node”, “interconnection” and “pin” are used interchangeably. Unless specifically stated to the contrary, these terms are generally used to mean an interconnection between or a terminus of a device element, a circuit element, an integrated circuit, a device, or other electronics or semiconductor component.

Unless otherwise stated, “about,” “approximately,” or “substantially” preceding a value means +/−10 percent of the stated value. Modifications are possible in the described examples, and other examples are possible within the scope of the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party. While, in some example embodiments, certain elements are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

Modifications are possible in the described examples, and other examples are possible, within the scope of the claims.

What is claimed is:

1. An apparatus comprising:
an H-bridge circuit having first and second outputs;
a first transistor, having a first terminal, a second terminal coupled to the first output, and a control terminal;
a second transistor, having a first terminal coupled to the first terminal of the first transistor, a second terminal coupled to the second output, and a control terminal;
a common mode circuit, having an enable input and an output coupled to the H-bridge circuit;
transistor driver circuitry, having an enable input, and having an output coupled to the control terminals of the first and second transistors; and
a comparator, having an input coupled to the first output, and having an output coupled to the enable input of the common mode circuit and the enable input of the transistor driver circuitry.

2. The apparatus of claim 1, wherein the H-bridge circuit comprises:
a first pull-up transistor coupled to the first output;
a first pull-down transistor coupled to the first output;
a second pull-up transistor coupled to the second output; and
a second pull-down transistor coupled to the second output.

3. The apparatus of claim 2, further comprising:
gate drivers, coupled to control terminals of the first and second pull-up and pull-down transistors;
wherein the gate drivers are configured to turn on the first pull-up transistor in a drive phase, and to turn off the first pull-up transistor in a recirculation phase.

4. The apparatus of claim 3, wherein the comparator is configured to provide an enable signal to the common mode circuit and the transistor driver circuit responsive to the voltage at the first output falling below a reference voltage.

5. The apparatus of claim 4, wherein the common mode circuit also has a first input coupled to the first output of the H-bridge circuit and a second input receiving a common mode voltage, the common mode circuit configured to control the H-bridge circuit to provide a common mode voltage at the first output responsive to the enable signal.

6. The apparatus of claim 5, wherein the reference voltage is the common mode voltage plus an offset voltage.

7. The apparatus of claim 3, wherein the gate drivers are further configured to turn on the first pull-down transistor during an initial portion of the recirculation phase.

8. The apparatus of claim 2, wherein the first and second transistors, and the first and second pull-up and pull-down transistors are n-channel metal-oxide-semiconductor (NMOS) transistors.

9. The apparatus of claim 8, wherein the first and second pull-up and pull-down transistors are NMOS power transistors.

10. An apparatus comprising:
an H-bridge circuit coupled to first and second outputs, the H-bridge circuit including first and second transistors coupled to the first output, and third and fourth transistors coupled to the second output, the first, second, third, and fourth transistors each having a control terminal;
a fifth transistor, having a first terminal, a second terminal coupled to the first output, and a control terminal;
a sixth transistor, having a first terminal coupled to the first terminal of the first transistor, second output coupled to the second output, and a control terminal; and
controller circuitry coupled to the control terminals of the first, second, third, fourth, fifth, and sixth transistors;
wherein the controller circuitry is configured to selectively turn on and turn off the first, second, third, and fourth transistors, and to turn on the fifth and sixth transistors during an interval in which the first, second, third, and fourth transistors are turned off.

11. The apparatus of claim 10, wherein the controller circuitry includes:
a comparator, having a first input coupled to the first output, a second reference voltage input, and an output; and
recirculation transistor driver circuitry, having an enable input coupled to the output of the comparator, and having outputs coupled to the control terminals of the fifth and sixth transistors.

12. The apparatus of claim 11, wherein the controller circuitry further comprises:
a common mode circuit, having an enable input coupled to the output of the comparator, and an output coupled to the first transistor in the H-bridge circuit, the common mode circuit configured to control a common mode voltage to be provided to the first output.

13. The apparatus of claim 12, wherein the common mode circuit comprises:
an operational amplifier, having a first input coupled to the first output, a second common mode voltage input, an enable input coupled to the output of the comparator, and an output coupled to a control terminal of the first transistor.

14. The apparatus of claim 12, wherein the comparator receives a reference voltage corresponding to the common mode voltage plus an offset at the second reference voltage input.

15. A method, comprising:
turning on a first pull-up transistor coupled to a first output of an H-bridge circuit;
turning off the first pull-up transistor;
turning on first and second transistors responsive to a voltage at the first output falling to a common mode voltage plus an offset, the first and second transistors having first terminals coupled together, the first transistor having a second terminal coupled to the first output, and the second transistor having a second terminal coupled to a second output of the H-bridge circuit; and
providing the common mode voltage to one of the first and second outputs of the H-bridge circuit.

16. The method of claim 15,
wherein turning on the first and second transistors comprises:
responsive to the voltage at the first output being below the common mode voltage plus the offset, enabling a transistor driver having outputs coupled to the first and second transistors.

17. The method of claim 16, wherein coupling the common mode voltage comprises:
responsive to the voltage at the first output being below the common mode voltage plus the offset, enabling a common mode circuit to control the common mode voltage to be provided at the first and second outputs of the H-bridge circuit.

18. The method of claim 17, wherein the enabling of the common mode circuit comprises:
enabling an operational amplifier in the common mode circuit having a first input coupled to the one of the first and second outputs of the H-bridge circuit, a second input receiving the common mode voltage, and an output coupled to a control terminal of the first pull-up transistor.

19. The method of claim 18, wherein the common mode voltage is at about a midpoint voltage between a voltage at the power supply terminal and a common potential.

20. The method of claim 16, further comprising:
during the turning on of the first pull-up transistor, turning on a second pull-down transistor coupled to a second output of the H-bridge circuit; and
during the turning off of the first pull-up transistor, turning off the second pull-down transistor.
